(19) United States
(12) Patent Application Publication
(10) Pub. No.: US 2002/0004739 A1
(43) Pub. Date: Jan. 10, 2002

(54) Internet adaptive discrete choice modeling

(76) Inventors: John B. Elmer, Houston, TX (US); D. T. Taylor, Houston, TX (US)

Correspondence Address: SOUTHWEST PATENT SERVICES COMPANY, 510 BERING DRIVE, SUITE 300, HOUSTON, TX, 77057, US

(21) Appl. No.: 09/899,603

(22) Filed: Jul. 5, 2001

Related U.S. Application Data
(60) Provisional application No. 60/215,795, filed on Jul. 5, 2000.

(51) Int. Cl. G06F 17/60

(52) U.S. Cl. 705/10

(57) ABSTRACT

Embodiments of our invention relate generally to determination of consumer preferences using a computer network, which may include the internet. More specifically, embodiments of this invention relate to adaptive discrete choice modeling via the Internet utilizing either wired or wireless means of interaction between two or more parties.

Embodiments of our invention concern certain methods of simulating a respondent's purchasing behavior. The methods include employing, as defined by a user, a substantially unlimited number of product attributes and a substantially unlimited number of product attribute levels, generally combined with a respondent's elimination of certain of those attributes and/or levels that do not figure into the respondent's purchasing decision or simulated purchasing response.

### RELATED APPLICATIONS

This application claims the benefit of U. S. Provisional Application No. 60/215,695, filed Jul. 5, 2000. Such benefit is provided under 37 CFR § 1.78 (a)(4) and 35 USC § 120.

### TECHNICAL FIELD

This invention relates generally to determination of consumer preferences using a computer network. More specifically, embodiments of this invention relate to adaptive discrete choice modeling via the Internet.

### DESCRIPTION

Introduction

Embodiments of our invention concern certain methods of simulating a respondent's purchasing behavior. The methods include employing, as defined by a user, a substantially unlimited number of product attributes and a substantially unlimited number of product attribute levels, generally combined with a respondent's elimination of certain of those attributes and/or levels that do not figure into the respondent's purchasing decision or simulated purchasing response.

Embodiments of this invention further include certain methods of communicating between a user and a plurality of respondents, such methods include both wired and wireless. Also contemplated is use of the Internet or other types of computer networks for use in communicating between the user and the plurality of respondents. The use of a computer network, including the internet, and adaptive discrete choice modeling has combinations of properties rendering these techniques superior to, and unique from, previously available experimental design, survey administration, survey sampling and forecasting techniques. The techniques described herein are particularly well suited for use in determining probable purchasing behavior. Those skilled in the art will appreciate that numerous modifications to these embodiments can be made without departing from the scope of the invention. For example, although use of questionnaires with substantially unlimited product attributes and use of a computer network are exemplified herein, the questionnaires and simulated purchasing behavior of the respondents may be obtained using combinations of other input and output devices and other types of products or services or combinations thereof are contemplated. To the extent our description is specific, it is solely for the purpose of illustrating embodiments of our invention and should not be taken as limiting the present invention to these embodiments.

Discrete Choice Modeling

Discrete choice modeling in general measures estimated purchasing likelihoods for products or services.

Adaptive Discrete Choice Modeling

Adaptive Discrete Choice Modeling (ADCM) allows the use of substantially unlimited product attributes and substantially unlimited product attribute levels when designing a discrete choice modeling survey to measure respondents' purchase likelihood for products or services.

User

A user as defined herein is any person, group, corporate entity, non-profit entity, manufacturer of a product, owner of a brand, provider of a service or combinations of one or more of these categories. A user is further defined as the party who desires the information from a respondent or a plurality of respondents, regarding their purchasing behavior, to permit the user to more accurately design a product or service, a logo, a name, or to gauge the salability or marketability or market penetrability of the product or service. The information may be preferences, real or simulated, of the respondents.

Respondent

A respondent, as defined herein, is an individual or a monolithic group of individuals who could form part of a market for the user's product or service.

Respondent's Preferences

A respondent's preferences are that group of data that define the simulated purchasing behavior of a respondent.

Population of Respondents

That group of individuals or monolithic group of individuals used to forecast the purchasing behavior or market share based on the defined attributes and levels of attributes and respondent's input or response to the discrete choice modeling questionnaire.

Purchase Likelihood

Purchase likelihood is the data obtained in response to a discrete choice modeling questionnaire in which simulated purchase decisions are made in response to survey questions constructed from user defined attributes and attribute levels.

Market Share

Market share is calculated as the ratio of sales of company's product or product line to the total market sales for that product or product line. This ratio is usually expressed as a percentage. Market share can be computed for local, state, national or international level.

Marketplace

The commercial sphere, where buying and selling takes place and the laws of supply and demand operates.

Purchasing Behavior

Among the benefits of ADCM is that a measure of actual purchasing behavior can be tested, rather than measuring of attitudes as done in other univariate survey research techniques. ADCM provides the user with the ability to measure and forecast a much wider set of purchasing behaviors because it can measure a substantially unlimited number of product attributes and attribute levels, rather than the limited number of product attributes and attribute levels required by non-adaptive or other versions or applications of discrete choice modeling.

Product Attributes

Product attributes as used herein describe the many facets, features and benefits of a particular product or service. Product attributes include, but are not limited to color, price, size, shape, speed, accuracy, quality, texture, weight, strength, duration, efficiency, complexity, turnaround time, volume, vulnerability, load capability, responsiveness, smoothness, flexibility, durability, maintainability, reliability, weight of moving object, weight of stationary object, length of moving object, length of stationary object, area of moving object, area of stationary object, volume of moving object, volume of stationary object, speed, force (intensity), stress or pressure, shape, stability of the object's composition, strength, duration of action of moving object, duration of action by stationary object, temperature, illumination intensity, use of energy by moving object, use of energy by stationary object, power, loss of Energy, loss of substance, loss of information, loss of time, quantity of substance/the matter, reliability, measurement accuracy, manufacturing precision, object-affected harmful factors, object-generated harmful factors, ease of manufacture, ease of operation, ease of repair, adaptability or versatility, device complexity, difficulty of detecting and measuring, extent of automation, productivity.

Product Attribute Levels

Product attribute levels are the individual components of product attributes. For example, while color may be a product attribute, red, green, blue, yellow, white, purple, brown, etc, are product attribute levels. Each attribute may have one or more levels, or two levels, or three, or 4 or 5 or 6 or 7 or 8 or 9 or 10 or more levels.

The number of attributes and attribute levels for adaptive choice modeling is substantially unlimited. By substantially unlimited, we intend 2, 3, 4, 5, 6, 7, 8, 9, 10, 11, 12, 13, 14, 15, 16, 17, or more up to 100, 200, 300 and all numbers in between. Although no upper limit is intended

Computer Network

The present techniques are implemented over a computer network, where each of the user and respondent (s) access a network by means of an input device and a display device. The input devices may be any method of communicating data, including but not limited to keyboard, central processing unit (CPU), personal digital assistant (PDA), cellular phone, or similar input device. A display device may be a video display (cathode ray tube or CRT), the display element of a PDA, display element of a cellular phone, or any display means.

By computer network we intend a means for communicating via two or more digital devices. The computer network may be the Internet. The means of communicating may be via hard wire, including fiber optics, or wireless.

Statistically Valid Mathematical Model

Generally, either Conjoint Analysis or Choice Modeling is known to employ statistically valid models.

Statistical Significance

An observed relationship that is large enough or strong enough not to be due to chance. Significant at the 0.05 level is the lowest threshold of significance to be used.

Significance tests are performed to see if the null hypothesis can be rejected. If the null hypothesis is rejected, then the effect found in a sample is said to be statistically significant. If the null hypothesis is not rejected, then the effect is not significant. The experimenter chooses a significance level before conducting the statistical analysis. The significance level chosen determines the probability of a Type I error. A statistically significant effect is not necessarily practically significant.

Application Service Provider

An application service provider (ASP) is an entity that offers individuals or enterprises access over the Internet, to application programs and related services that would otherwise have to be located in their own personal or enterprise computers.

Questionnaire

In general describes the data set of product attributes and attribute levels. A set of questions used to gather information in a survey, or the printed paper, computer screen or other display mechanism that contains the questions. Questionnaires are used to conduct opinion polls and other types of survey research. Survey research is generally accepted as a useful tool by business, political organizations, the mass media, and government as well as in academic research. In business, surveys are used to test consumers' preferences and to discover what it is about a product that gives it appeal. Response to commercial survey aids in planning marketing and advertising strategies and in making changes in a product to increase its sales.

Definition of Terms

Attribute A feature or benefit of a product. e.g. fuel economy.

Attribute Level A different value for an attribute. e.g. excellent fuel economy, low fuel economy or 10 mpg (miles per gallon) 15 mpg, 20 mpg, 25 mpg.

Experiment Design A specific design of an experiment that specifies enough experiment trials (data points) that the unique contribution of each attribute to the total response can be calculated. See “An Introduction to the Theory of Experimental Design”, D. J. Finney,

University of Chicago Midway Reprints.

Process

Alternative A

1. Respondent is presented with all possible attributes. He/she is asked to divide the attributes into three categories.

a. Very important

b. Useful

c. Unimportant

2. Limiting the levels of attributes

a. For Very important attributes, the respondent is shown a list of attribute levels. The respondent is asked to select any level of the attribute he might reasonably expect to want.

b. For Useful attributes, the respondent is shown a list of attribute levels. The respondent is asked to select no more than two levels of the attribute he might reasonably expect to want.

c. For unimportant attributes, the respondent is shown a list of attribute levels. The respondent is asked to select one level of the attribute he might reasonably expect to want.

3. The logic creates an analytical hierarchy (Ref. Dr. Tom Saaty, University of Pittsburgh) of the very important attributes. See “The Analytical Hierarchy Process RSW Publishers”, incorporated herein by reference for purposed of U.S. patent practice.

a. Respondent completes the analytical hierarchy task.

4. Optionally, the logic asks the respondent to create an ordered list of attributes from the useful attributes list.

5. For each very important attribute, the respondent is shown an analytical hierarchy of the attribute levels.

a. The respondent chooses the relative importance of each attribute level.

6. The very important attributes, logic calculates the relative values of each attribute and each attribute level. For useful and unimportant attributes, the logic assumes certain values of importance as defined by the user. The logic now creates a con-joint experiment (Green, Paul E./Rao, Vithala R. (1971) “Conjoint Measurement for Quantifying Judgmental Data”, in: Journal of Marketing Research. Incorporated herein by reference for purposes of U.S. patent practice) or a choice model experiment or other appropriate multi-task trade-off experiment.

a. The user will pre designate the complexity allowed for the resulting conjoint or choice model. If the automated design is too complex, the logic will select only the highest value attributes for the design.

7. The respondent is now finished.

8. The software compares the respondent results to the results from the con-joint or the choice model. Differences between the results are attributed to interaction between the attributes.

a. Techniques such as genetic algorithms, or neural networks, mathematical programming, or other iterative drive mathematics techniques may be used to identify the most like source and contribution of attribute interaction.

9. The software compares the results from step 7 with the results predicted based on step 3. Significant variance between these two will, in certain circumstances, be attributed to consistency or inconsistency of the respondent

10. Results from respondents may be clustered into like groups at any appropriate step along the process to aid in developing identifiable groupings of respondents, which would represent different segments of the population.

a. This option would most likely be initiated after step 8.

11. Final report for each respondent includes relative values of each attribute and attribute levels, plus analysis of interaction between the attributes plus consistency of the respondent.

a. Reports on the individual level and for different segments of the total population will be available.

Alternative B

1. Respondent is presented with substantially all attributes. He/she may be asked to divide the attributes into three categories.

b. Very important

c. Useful

d. Unimportant

2. Limiting the levels of attributes

a. For very important attributes, the respondent is shown a list of attribute levels. The respondent is asked to select any level of the attribute he/she might reasonably expect to want. For example, a car, it might have two doors, three doors, four doors, five doors. The respondent may, for instance, say four and five door cars only.

b. For useful attributes, the respondent is shown a list of attribute levels. The respondent is asked to select no more than two levels of the attribute he might reasonably expect to want. An example of a useful attribute may be cup holders. The choices could be one for every seat, one for every row of seats, or no cup holders. The respondent may likely eliminate the no cup holders option and keep the other two options.

c. For unimportant attributes, the respondent is shown a list of attribute levels. The respondent is asked to select one level of the attribute he might reasonably expect to want. An unimportant attribute could be the choice between drum brakes or disk brakes.

3. At this point the set of all reasonable choices which the respondent might choose has been established.

4. The number of possible choices in the set is typically still large. The respondent can only evaluate a small number of these choices before the respondent becomes tired, resistant, or overwhelmed by the choices. Typically the limit is time. Experience shows that it should take no more than 12-15 minutes for a completed survey. Therefore, depending on the size of this set of options, the survey logic will take specific paths. The particular path may be determined in advance by the user in creating the survey.

a. One path is to only ask the respondent a small random subset of the choices.

b. Another path is to consult a database of answers from prior respondents for this survey and ask this respondent questions consisting of random choices from a subset of choices which excludes choices previously shown to prior respondents.

c. Another path is to use ‘design of experiments’ techniques (ref: D. J. Finney, “An Introduction to the Theory of Experimental Design”, University of Chicago Press—Midway Reprints, incorporated herein by reference for purposes of U.S. patent practice) and either predefined experiments or extemporaneous user designed experiments, then select an experiment that closest fits the respondents answers, and have the respondent do the tasks which would meet the data needs for the specific experiment. In using ‘design of experiments’ techniques we assumed that respondents are directed to specific designs and that the software has the objective of receiving balanced responses across all of the designs. Balanced responses are defined as all options presented to respondents an equivalent number of times, so that one option does not appear to be preferred just because it was asked more than the others.

d. Another path is to just have a fixed number of empirically selected groups of choices that the respondent is assigned to answer one of the selected groups. The software would assign the groups sequentially or randomly.

5. In step 4 there is an assumption that the task is so large that no one respondent can give the complete answer. The techniques in step 4 are designed to aggregate the information from several respondents to give the complete picture of how respondents are likely to respond. This aggregation may be accomplished in at least two ways:

a. Add responses while the universe of possibilities stays wide.

b. As responses are added, as it becomes apparent that certain attributes or levels of attributes are relatively unimportant, these relatively unimportant attributes may be dropped from the possible universe of choices, thereby focusing more data on the choices that are relatively more important. Relatively unimportant attributes are those that get picked measurably fewer times than the other alternatives.

6. In some situations, respondent answers may be grouped into population segments. This grouping may be done in at least two ways.

a. Based on separate demographic or screening questions, respondents may be placed in separate groups before the processes described in steps 4, 5, & 6.

b. Alternatively, in cases with sufficient data, clustering of respondents based on demographic or classification questions can be done after the data collection.

7. The respondent is now finished.

8. Data analysis on this data set is based on steps 4-6 producing an array of responses. For example, if there were 10 questions with 5 possible answers each, an array is formed that is 10 by 5 by 2. The 2 would hold two values, the number of times the item had been presented to respondents and the number of times this attribute had been chosen. There may be many points in the array with no data. These points will be filled in with regression or interpolation techniques.

9. At this point each cell in the array will have a likelihood of selection score. A purchase likelihood simulator that presents the results of product alternatives in terms of market shares can be used.

Conclusion

The present invention has been described in considerable detail with reference to certain versions thereof, other versions are possible. For example, while adaptive discrete choice modeling conducted over a computer network or the Internet are exemplified, other uses are also contemplated. Therefore, the spirit and scope of the appended claims should not be limited to the description of the versions contained herein.

1. A system for presenting a substantially unlimited set of product attributes and/or product attribute levels, to a plurality of individual respondents, while maintaining a statistically valid mathematical model, presenting said substantially unlimited set of product attributes and/or product attribute levels, by means of a computer network, comprising:
a) a user, inputting said substantially unlimited set of product attributes and/or product attribute levels to one of an application service provider (ASP), a web server providing service, or an internet server, via a data communication means;
b) said ASP, a web server providing service, or an internet server, defining a questionnaire for use/input by a plurality of individual respondents;
c) said plurality of individual respondents, each responding to said questionnaire:
i) eliminating those product attributes that would not be considered in said individual respondent's buying decision;
ii) from the product attributes that would be considered, producing a hierarchy of said product variables;
d) said ASP, said web server providing service, or said internet server, upon receiving inputs from said plurality of individual respondents, providing said user with an estimate of the purchase likelihood of any combination of the substantially unlimited set of product attributes and/or product attribute levels to a potential consumer group represented by said individual respondents.

2. A system for users to collect respondent information for the purpose of determining a respondent's preferences for a plurality of product attributes and/or product attribute levels offered by a user for a product:
a) said user designing an online questionnaire to test respondent's interest/desire for product attributes;
i) listing product attributes;
ii) listing product attribute levels;
iii) said user determining size of a population of respondents to be surveyed;
iv) said user determining a duration of said respondent's interaction with said survey;
b) said respondent receiving said questionnaire over a network;
i) said respondent eliminating attributes that do not factor into a respondent's individual selection decision;
c) said system responding to both a) and b) to deliver to said respondent a customized questionnaire;
d) said respondent receiving said customized questionnaire over said network, said respondent answers questions on said questionnaire by use of an input device; said answers being transmitted via a network to said user;
e) said user receiving a plurality of completed customized questionnaires;
f) said system analyzing said completed questionnaires;
whereby said system enables said user to design one or more products based on the responses from a plurality of respondents, such that said product includes attributes that most match the answers indicating relative importance of said attributes to a group of respondents' likely buying behavior.

3. The system for users to collect respondent information of claim 2 wherein said plurality of respondents is a statistically significant number.

4. The system for users to collect respondent information of claim 3 wherein the level of significance is greater than one standard deviation from the mean

5. A method for determination of an optimum combination of product attributes, by a product's producer or designer, through online adaptive discrete choice modeling, by facilitating interactions between said producer or designer and a plurality of respondents, over a computer network, said network providing communication between said producer and said plurality of respondents, or vice versa, wherein said respondents have one or more display mechanisms and one or more input mechanisms, comprising:
a) said producer or designer submitting a plurality of product attributes, into a data mechanism for a user to design a questionnaire;
b) said plurality of respondents retrieving said questionnaire;
c) said plurality of respondents, each deselecting attributes that do not enter into an individual respondent's decision to purchase said product; and
d) ranking the attributes not deselected by said respondent, said respondent communicating said ranking of said attributes to said producer.

6. A method for collecting respondent data for the purpose of using said data to determine which of a product's attributes to include in manufacturing, specifying, constructing or designing said product to maximize the probability that products produced match consumer preferences, comprising:
a) a user inputting two or more product attributes into a program which designs a questionnaire for said respondents input;
b) said respondent eliminating one or more attributes that do not figure in said respondent's buying decision;
c) said respondent ranking the remaining product attributes;
d) said respondent communicating said ranking to said producer;
e) said producer gathering the rankings from two or more respondents; and
f) said producer producing a product based on said ranking from said two or more respondents.

7. A system for online adaptive choice modeling, comprising:
a) a product user entering an unlimited number of product attributes relating to a product made by said user into a server;
b) based on said attributes, generating a query form to be available on a computer network;
c) at least a first respondent accessing said query form on said computer network through an input device;
d) said respondent eliminating product attributes that do not impact said respondent's decision on whether to choose said product;
e) with the remaining product attributes, said respondent rank ordering each attribute of said product;
f) said respondent communicating both said d) and e) to said user by said computer network;
g) based on a plurality of respondents communicating to said user, said user builds a product to match as many of said attributes with a high rank order as deemed necessary to positively affect choice of said product by a group of consumers represented by said plurality of respondents.

8. A method for simulating purchasing behavior, using the internet, comprising:
a) providing a substantially unlimited number of attributes to at least one potential respondent;
b) providing a substantially unlimited number of levels within said attributes to said at least one potential respondent;
c) said at least one potential respondent eliminating one or more of said attributes, levels within said attributes, or combinations thereof, that would not be a part of said potential respondents' purchasing decision;
d) from the remaining attributes and or levels, said respondents assigning a highest to lowest value to each said remaining attributes and or levels;
e) collecting a sufficient number of said respondent's assigned values to said attributes and or levels.

9. The method of claim 8, wherein said collected assigned values are used in determining a product's likelihood of purchase by said respondent.

10. The method of claims 8 or 9 wherein said at least one potential respondent produces a statistically valid number.

11. The method of claim 8 wherein a user determines the number and type of attributes and or levels.

12. The method of claim 11 wherein said user and said one or more respondents are communicating over the Internet.

13. The method of claim 12 wherein each of said user and said at least one respondent have a display means and an input means.
